(19) United States
(12) Patent Application Publication
(10) Pub. No.: US 2023/0373343 A1
(43) Pub. Date: Nov. 23, 2023

(54) VEHICLE AND CONTROL METHOD THEREOF

(71) Applicants: Hyundai Motor Company, Seoul (KR); Kia Corporation, Seoul (KR)

(72) Inventor: Hyo Geun KWAK, Hwaseong-si (KR)

(73) Assignees: Hyundai Motor Company, Seoul (KR); Kia Corporation, Seoul (KR)

(21) Appl. No.: 18/077,517

(22) Filed: Dec. 8, 2022

(30) Foreign Application Priority Data
May 23, 2022 (KR) 10-2022-0062884

(51) Int. Cl. B60L 58/12; B60L 58/18

(52) U.S. Cl. CPC B60L 58/12; B60L 58/18; B60L 2260/00; B60L 2240/60

(57) ABSTRACT

A vehicle includes a driving motor, an electric load, a first battery electrically connected to the driving motor and configured to supply a power of a first voltage to the driving motor, a second battery electrically connected to the electric load and configured to supply a power of a second voltage to the electric load, a direct-current converter electrically connected to the first battery and the second battery between the first battery and the second battery, and a controller operatively connected to the direct-current converter and configured to control the direct-current converter to supply the power of the first battery to the second battery and to warn a low state of charge (SOC) value of the first battery based on an SoC of the first battery and a distance of the vehicle to a charging station for charging the first battery during supply of the power of the first battery to the second battery.

### CROSS-REFERENCE TO RELATED APPLICATION(S)

The present application claims priority to Korean Patent Application No. 10-2022-0062884, filed on May 23, 2022, the entire contents of which is incorporated herein for all purposes by this reference.

### BACKGROUND OF THE PRESENT DISCLOSURE

### Field of the Present Disclosure

The present disclosure relates to a vehicle and a control method thereof, and more particularly, to a vehicle including a battery pack configured for outputting power of various voltages, and a method of controlling the vehicle.

### Description of Related Art

In general, a vehicle refers to a transportation means or a transport means that travels on a road or a track using fossil fuels, electricity, etc., as a power source.

Research on electric vehicles using only electricity as an energy source has been actively conducted. An electric vehicle includes a battery as a driving energy source for moving the vehicle, and also includes a battery as an auxiliary energy source for providing convenience and safety to a driver.

Moreover, with the recently increasing interest in camping, the use of batteries in electric vehicles as a power source in campsites without accommodation is increasing.

However, when electrical energy stored in the battery is consumed all for purposes other than driving of the vehicle, the vehicle may not be driven.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle that limits power consumption for driving and allows power consumption of an electric field load according to a user input, and a method of controlling the vehicle.

Another aspect of the present disclosure is to provide a vehicle that warns about a low state of charge (SOC) value of a battery according to an SOC value of the battery while allowing power consumption of an electric load, and a method of controlling the vehicle.

Additional aspects of the present disclosure will be set forth in part in the description which follows, and in part, will be obvious from the description, or may be learned by practice of the present disclosure.

In accordance with an aspect of the present disclosure, a vehicle includes a driving motor, an electric load, a first battery electrically connected to the driving motor and configured to supply a power of a first voltage to the driving motor, a second battery electrically connected to the electric load and configured to supply a power of a second voltage to the electric load, a direct-current converter electrically connected to the first battery and the second battery between the first battery and the second battery, and a controller operatively connected to the direct-current converter and configured to control the direct-current converter to supply the power of the first battery to the second battery and to warn a low state of charge (SOC) value of the first battery based on an SOC value of the first battery and a distance of the vehicle to a charging station for charging the first battery during supply of the power of the first battery to the second battery.

The controller may be further configured to receive, from a navigation of the vehicle, information related to a plurality of charging stations located within a predetermined distance from the vehicle during supply of the power of the first battery to the second battery.

The controller may be further configured to increase the predetermined distance and receive information related to a plurality of charging stations located within the increased predetermined distance from the navigation, when a number of the plurality of charging stations located within the predetermined distance is less than a reference value and the predetermined distance is less than a reference distance.

The controller may be further configured to identify a maximum value, a minimum value, and a middle value of an actual traveling distance in the vehicle to each of the charging stations.

The controller may be further configured to identify a distance to empty of the vehicle based on the SOC value of the first battery and an average energy efficiency of the vehicle and warn the low SOC value of the first battery based on a result of comparing each of the maximum value, the minimum value, and the middle value of the actual traveling distance with the distance to empty.

The controller may be further configured to output a first warning when the distance to empty of the vehicle is less than the maximum value of the actual traveling distance, to output a second warning when the distance to empty of the vehicle is less than the middle value of the actual traveling distance, and to output a third warning when the distance to empty of the vehicle is less than the minimum value of the actual traveling distance.

The controller may be further configured to identify an available time of the first battery based on the SOC value of the first battery and a power consumption per unit time of the electric load and to identify the distance to empty in each period based on the available time.

The controller may be further configured to identify the average energy efficiency of the vehicle during a predetermined time period.

The controller may be further configured to allow the first battery to supply the power of the first voltage to the driving motor and the second battery to supply the power of the second voltage to the electric load, in a first mode and to block supply of the power of the first voltage to the driving motor from the first battery and allow the second battery to supply the power of the second voltage to the electric load, in a second mode.

The controller may be further configured to switch to the second mode when a shift state of the vehicle is a parking state, a parking brake of the vehicle is engaged, and a user input for switching to the second mode is obtained, in the first mode.

In accordance with another aspect of the present disclosure, a method of controlling a vehicle includes supplying, by a first battery of the vehicle, a power of a first voltage to a driving motor, supplying, by a second battery of the vehicle, a power of a second voltage to an electric load, supplying the power of the first battery to the second battery, and warning a low state of charge (SOC) value of the first battery based on an SOC value of the first battery and a distance of the vehicle to a charging station for charging the first battery during supply of the power of the first battery to the second battery.

According to an aspect of the present disclosure, a vehicle that limits power consumption for driving and allows power consumption of an electric load according to a user input, and a method of controlling the vehicle may be provided. Hence, the vehicle may provide a required power to a user while being stopped.

According to another aspect of the present disclosure, a vehicle that warns about a low SOC value of a battery according to an SOC value of the battery while allowing power consumption of an electric load, and a method of controlling the vehicle may be provided. Hence, it is possible to restrain or prevent the vehicle from being unable to be driven due to deep discharging of the battery.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 simply illustrates a structure of a vehicle according to an exemplary embodiment of the present disclosure;

FIG. 2 illustrates an operation mode of a vehicle according to an exemplary embodiment of the present disclosure;

FIG. 3 illustrates a method, performed by a vehicle, of switching an operation mode, according to an exemplary embodiment of the present disclosure;

FIG. 4 illustrates a method, performed by a vehicle, of preventing deep discharging of a battery, according to an exemplary embodiment of the present disclosure;

FIG. 5 and FIG. 6 illustrate an example of identifying a location of a charging station as shown in FIG. 4; and

FIG. 7 illustrates a method, performed by a vehicle, of preventing deep discharging of a battery, according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Like reference numerals refer to like elements throughout. The present specification does not describe all elements of the disclosed exemplary embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Furthermore, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements included in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operating principles and embodiments of the present disclosure will be described in detail with reference to the accompanying drawings.

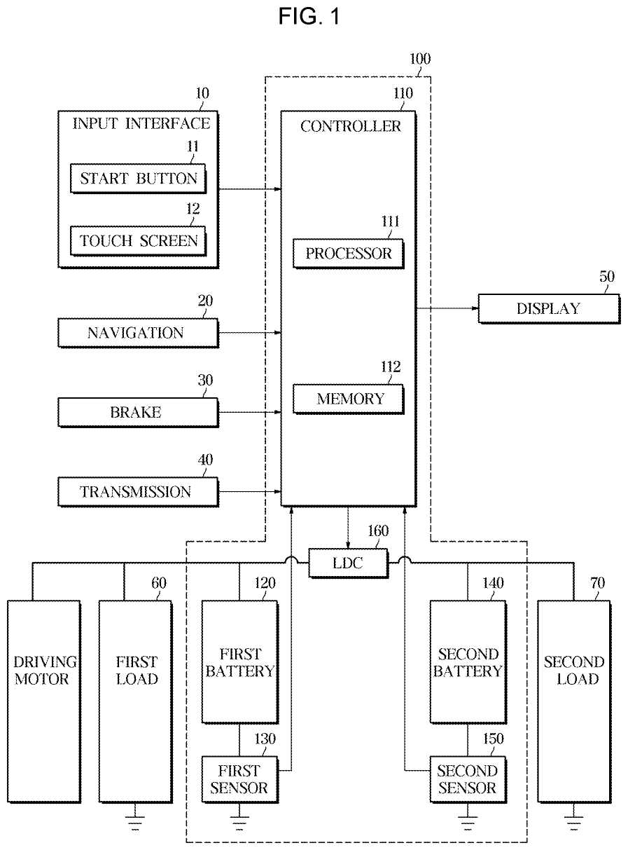

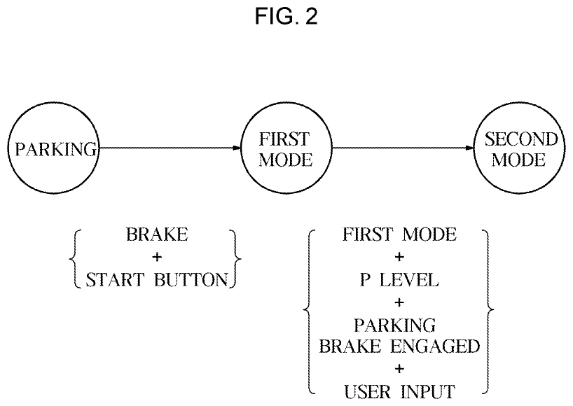

FIG. 1 simply illustrates a structure of a vehicle according to an exemplary embodiment of the present disclosure. FIG. 2 illustrates an operation mode of a vehicle according to an exemplary embodiment of the present disclosure.

Referring to FIG. 1 and FIG. 2, a vehicle may include an input interface 10, a navigation 20, a brake 30, a transmission 40, a display 50, a first load 60, a second load 70, and a power source device 100.

The input interface 10 may obtain a user input and include a start button 11 and a touch screen 12. The input interface 10 may output an electric signal corresponding to the user input.

The start button 11 may obtain a user input for switching to a ready state for driving the vehicle. In response to the user input based on the start button 11, the vehicle may switch to a drivable state. For example, the vehicle may supply power to a driving motor, a transmission, a brake, and/or steering, and supply power to electric parts that assist driving of a driver.

The touch screen 12 may be provided integrally with the display 50 and obtain a touch input of a user. The touch screen 12 may identify a user input based on comparison between a position of an image (e.g., a select button, etc.) displayed on the display 50 and a position of the touch input. For example, when a plurality of menus are displayed on the display 50 and the user touches a region corresponding to a menu, the touch screen 12 may identify the user-selected menu by comparing a position of each of menus with the position of the touch input.

The input interface 10 may be electrically connected to the power source device 100. For example, the input interface 10 may be connected to the power source device 100 through a communication network, and may provide an input signal corresponding to the user input to the power source device 100 through the communication network.

The navigation 20 may generate a path to a destination input by the driver and provide the generated path to the driver. The navigation 20 may receive a global navigation satellite system (GNSS) signal from the GNSS and identify an absolute position (coordinates) of the vehicle based on the GNSS signal. The navigation 20 may generate the path to the destination based on the position (coordinates of the destination, input by the driver, and a current position (coordinates) of the vehicle.

The navigation 20 may be electrically connected to the power source device 100, and provide map data and position information of the vehicle to the power source device 100. For example, the navigation 20 may be connected to the power source device 100 through the communication network, and provide information related to locations of charging stations around the vehicle to the power source device 100 through the communication network.

The brake 30 may stop the vehicle and may include, for example, a brake caliper and an electronic brake control module (EBCM). The brake caliper may decelerate or stop the vehicle by use of friction with a brake disk. The EBCM may control the brake caliper in response to a driver's brake will through a brake pedal. Furthermore, the brake 30 may be engaged with a parking brake during parking of the vehicle, and lock a wheel of the vehicle by engagement with the parking brake.

The brake 30 may be electrically connected to the power source device 100, and provide information related to an operation state of the brake 30 to the power source device 100. For example, the brake 30 may provide information related to whether a brake operates and/or information related to whether the parking brake is engaged to the power source device 100 through the communication network.

The transmission 40 may include a transmission mechanism and a transmission control unit (TCU). The transmission mechanism may decelerate and transmit power generated by an engine to a wheel, and the TCU may control the transmission mechanism in response to a shift command of the driver through a shift lever and/or a request from a driver assistance device.

The transmission 40 may be electrically connected to the power source device 100, and provide information related to an operation state of the transmission 40 to the power source device 100. For example, the transmission 40 may provide information related to a shift state such as drive, neutral, reverse, park, etc., to the power source device 100 through the communication network.

The display 50 may include a cluster, a head-up display, a center fascia monitor, etc., and provide various information and entertainment to the driver through images and audios. For example, the display 50 may provide driving information of the vehicle, a warning message, etc., to the driver.

The display 50 may be electrically connected to the power source device 100, and receive information related to a state of charge (SOC) value of the battery from the power source device 100. For example, the display 50 may receive a message for warning a low SOC value of the battery from the power source device 100 through the communication network. The display 50 may display an image corresponding to the received warning message.

The first load 60 and the second load 70 may obtain a power from the power source device 100.

The first load 60 may obtain a high-voltage power from the power source device 100, and the second load 70 may obtain a low-voltage power including a voltage lower than the first load 60 from the power source device 100. For example, the first load 60 may include a driving motor configured for driving the vehicle, an air conditioner for controlling the temperature of the vehicle, etc. A high-voltage power including a voltage between about 200 V (volt) and 800 V may be supplied to the first load 60. The second load 70 may include various electronic parts that provide convenience and safety to the driver. A low-voltage power including a voltage between about 12V (volt) and 48V may be supplied to the second load 70.

The power source device 100 may supply a power to electric devices included in the vehicle. For example, the power source device 100 may supply a high-voltage power to the first load 60 and supply a low-voltage power to the second load 70.

The power source device 100 may include a first battery 120, a first sensor 130, a second battery 140, a second sensor 150, a direct-current converter 160, and a controller 110.

The first battery 120 may store electrical energy and may be electrically connected to the first load 60. The first battery 120 may supply a high-voltage power to the first load 60 that consumes a high power, such as the driving motor, the air conditioner, etc., of the vehicle. The first battery 120 may output a voltage between about 200V (volt) and 800 V to supply a high-voltage power to the first load 60.

The first sensor 130 may detect an output (an output voltage, an output current, etc.) of the first battery 120. The first sensor 130 may also output battery data indicating a charging state of the first battery 120. For example, the first sensor 130 may determine an SOC value of the first battery 120 based on an output voltage of the first battery 120, an output current of the first battery 120, a temperature of the first battery 120, etc. The SOC value of the first battery 120 may indicate a degree to which electrical energy is stored in the first battery 120. The SoC may generally have a value of 0-100%, and a degree to which the first battery 120 is charged may be indicated between a deep discharging state (0%) and a full SoC (100%). The SOC value of the first battery 120 may be determined based on an open circuit voltage (OCV) of the first battery 120 and input/output current of the first battery 20.

The first sensor 130 may be electrically connected to the controller 110, and may provide the battery data of the first battery 120 to the controller 110.

The second battery 140 may store electrical energy and may be electrically connected to the second load 70. The first battery 120 may supply a low-voltage power to the second load 70 that consumes a low power, such as a navigation, an audio, a display, etc. The first battery 120 may output a voltage between about 12 V and 48 V to supply a high-voltage power to the first load 60.

The second sensor 150 may detect an output (an output voltage, an output current, etc.) of the second battery 140. The second sensor 150 may also output battery data indicating a charging state of the second battery 140. For example, the second sensor 150 may determine an SOC value of the second battery 140 based on an output voltage of the second battery 140, an output current of the second battery 140, a temperature of the second battery 140, etc.

The second sensor 150 may be electrically connected to the controller 110, and may provide the battery data of the second battery 140 to the controller 110.

The direct-current converter 160 may be provided between the first battery 120 and the second battery 140. The direct-current converter 160 may convert a voltage of a power, and provide a power of the first battery 120 to the second battery 140 or a power of the second battery 140 to the first battery 120. For example, the direct-current converter 160 may convert a high voltage of the first battery 120 into a low voltage of the second battery 140 according to a control signal of the controller 110 to output the low voltage to the second battery 140, or may convert the low voltage of the second battery 140 into the high voltage of the second battery 140 to output the high voltage to the first battery 120.

The controller 110 may control power supply to electric devices of the vehicle. The controller 110 may include a processor 111 that generates a control signal for controlling an operation of the power source device 100 and a memory 112 that stores or memorizes a program and/or data for controlling the operation of the power source device 100. The processor 111 and the memory 112 may be implemented as separate semiconductor devices or a single semiconductor device. The controller 110 may include a plurality of processors or a plurality of memories.

The memory 112 may include a volatile memory such as a static random access memory (S-RAM), a dynamic random access memory (D-RAM), etc., and a non-volatile memory such as read only memory (ROM), erasable programmable read only memory (EPROM), etc., and may store or memorize a program and/or data for controlling the power source device 100. The memory 112 may include a single memory element or a plurality of memory elements.

The processor 111 may include a microprocessor, a microcontroller, an application specific integrated circuit (ASIC), or a field programmable gate array (FPGA). The processor 111 may include a single processor or a plurality of processors.

The controller 110 may control an operation of the direct-current converter 160 and display a message on the display 50, based on a user input through the input interface 10, a braking state of the brake 30 and/or a shift state of the transmission 40, an SOC value of the first battery 120 and/or an SOC value of the second battery 140.

The vehicle may also operate in a plurality of different operation modes based on the user input through the input interface 10, the braking state of the brake 30 and/or the shift state of the transmission 40.

The vehicle may operate in a first mode where driving is allowed and a power is supplied to electronic parts or in a second mode where a power is supplied to the electronic parts.

In the first mode, the vehicle may operate the electronic parts and may be driven in response to an acceleration command of the driver through an accelerator pedal.

In the first mode, the controller 110 may control the power source device 100 to supply a power to the electronic parts of the vehicle. In the first mode, the controller 110 may control the power source device 100 to supply a high-voltage power to the driving motor in response to the acceleration command of the driver through the accelerator pedal. In the first mode, the controller 110 may allow the first battery 120 to supply the high-voltage power to the first load 60 including the driving motor and the air conditioner. The controller 110 may also allow the second battery 140 to supply the low-voltage power to the second load 70.

The controller 110 may switch to the first mode when obtaining, from the user, a user input for switching to a ready state for driving the vehicle. For example, as illustrated in FIG. 2, the controller 110 may control the brake 30 to brake the vehicle during parking of the vehicle and may switch to the first mode upon input of the user input through the start button 11.

In the second mode, the vehicle may operate the electronic portions, but may not be driven in spite of the acceleration command of the driver through the accelerator pedal.

In the second mode, the controller 110 may control the power source device 100 to supply a power to the electronic parts of the vehicle. On the other hand, in the second mode, the controller 110 may control the power source device 100 not to supply a high-voltage power to the driving motor in spite of obtaining the acceleration command of the driver through the accelerator pedal. In the second mode, the controller 110 may allow the second battery 140 to supply the low-voltage power to the second load 70, but may block supply of the high-voltage power to the driving motor from the first battery 120.

The controller 110 may switch to the second mode when obtaining, from the user, a user input for switching the vehicle to a state for providing a convenience function. For example, as illustrated in FIG. 2, the controller 110 may switch to the second mode when a shift state is a parking state, the parking brake is engaged, and a user input for the second mode is obtained, during an operation of the vehicle in the first mode.

In the second mode, the controller 110 may charge the second battery 140 by use of the high-voltage power of the first battery 120 based on the SOC value of the second battery 140 output from the second sensor 150. That is, the controller 110 may control the direct-current converter 160 to convert the high-voltage power of the first battery 120 into a low-voltage power.

In the second mode, the controller 110 may warn the driver for the low charging state of the first battery 120 based on the SOC value of the first battery 120 output from the first sensor 130. For example, when the first battery 120 enters the deep charging state, the vehicle may not be able to move to a nearby charging station. To prevent the present situation, the controller 110 may warn the user for a low SOC value of the first battery 120 through the display 50 before the SOC value of the first battery 120 enters the deep discharging state.

As described above, the vehicle may operate in the first mode where driving is allowed and in the second mode where driving is not allowed. The vehicle may warn the user for the low SOC value of the first battery 120 in the second mode where driving is not allowed. Thus, in the second mode, the vehicle may provide convenience other than driving to the user and prevent driving of the vehicle from being limited due to deep discharging of the first battery.

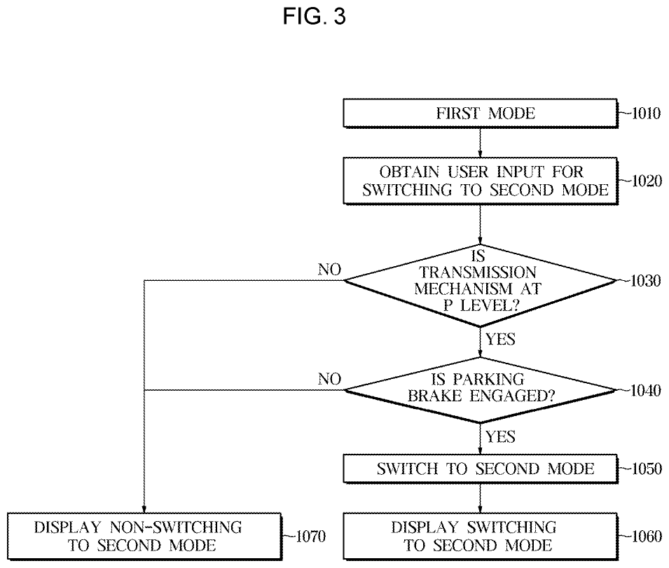

FIG. 3 illustrates a method, performed by a vehicle, of switching an operation mode, according to an exemplary embodiment of the present disclosure.

Referring to FIG. 3, the vehicle may operate in the first mode, in operation 1010.

When the user steps on the brake pedal and presses the start button 11 while the vehicle is parked, the vehicle may switch to the first mode which is the ready state for driving the vehicle.

The first mode may be a state where the vehicle prepares for driving. In the first mode, when the user steps on the acceleration pedal, the controller 110 may allow the first battery 120 to supply the high-voltage power to the driving motor and the vehicle may start driving.

In the first mode, the vehicle may obtain a user input for switching to the second mode, in operation 1020.

The controller 110 may obtain the user input for switching to the second mode through the touch screen 12. A menu for switching to the second mode may be displayed on the display 50, and when the user touches a region corresponding to the menu, the controller 110 may identify the user input for switching to the second mode based on coordinates of a touch input output on the touch screen 12.

The vehicle may identify whether the shift state of the transmission 40 is a parking state (P level), in operation 1030.

The transmission 40 may provide the shift state of the transmission scheme to the controller 110 of the power source device 100 through the communication network.

The controller 110 may obtain information related to the shift state of the vehicle through the communication network. The controller 110 may identify whether the shift state of the vehicle is the parking state (P level), based on information related to the shift state of the vehicle.

When the shift state is the parking state (P level) (Yes in operation 1030), the vehicle may identify whether the parking brake is engaged, in operation 1040.

The brake 30 may provide an engaged state of the parking brake to the controller 110 of the power source device 100 through the communication network.

The controller 110 may obtain information related to the engaged state of the parking brake through the communication network. The controller 110 may identify whether the parking brake of the vehicle is engaged, based on the engaged state of the parking brake.

When the parking brake is engaged (Yes in operation 1040), the vehicle may switch to the second mode, in operation 1050.

When the shift state is the parking state (P level) and the parking brake is engaged, it may be expected that the vehicle may not be driven. The controller 110 may switch to the second mode when the shift state is the parking state (P level) and the parking brake is engaged.

The second mode may be a state where the vehicle is not being driven. In the second mode, even when the user steps on the acceleration pedal, the controller 110 may allow the first battery 120 to supply the high-voltage power to the driving motor and the vehicle may start driving.

However, in the second mode, the controller 110 may allow the first battery 120 to still supply the high-voltage power to the air conditioner and allow the second battery 140 to supply the low-voltage power to the second load 70. The controller 110 may also allow the first battery 120 to supply a power to the second battery 140. As a result, the SOC value of the second battery 140 may decrease over time.

The vehicle having switched to the second mode may display that the vehicle has switched to the second mode, in operation 1060.

The controller 110 may transmit a communication signal to the display 50 to display a message indicating that the vehicle has switched to the second mode. The display 50 may display the message indicating that the vehicle has switched to the second mode, in response to the communication signal of the controller 110.

When the shift state is not the parking state (No in operation 1030) or the parking brake is not engaged (No in operation 1040), the vehicle may display that the vehicle has not switched to the second mode, in operation 1070.

When the shift state is not the parking state or the parking brake is not engaged, the vehicle may maintain the first mode without switching to the second mode. The vehicle may display, on the display 50, a message indicating that the first mode is maintained without switching to the second mode.

The vehicle may also display a reason for non-switching to the second mode on the display 50. For example, the vehicle may display, on the display 50, that the shift state is not the parking state or that the parking brake 30 is not engaged.

As described above, the vehicle may operate in the second mode where driving is not allowed, in response to the user input. In the second mode, the power source device 100 may not supply a power to the driving motor, but may supply a power to the electronic parts of the vehicle.

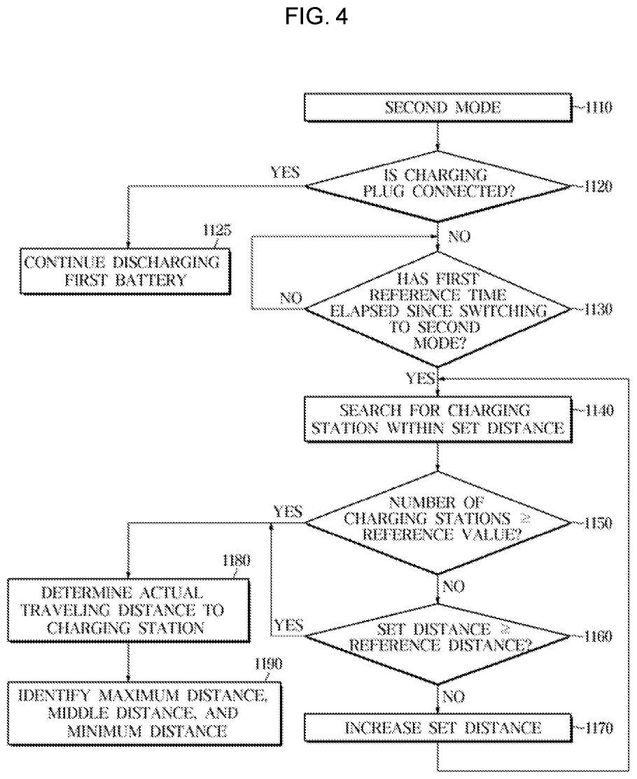

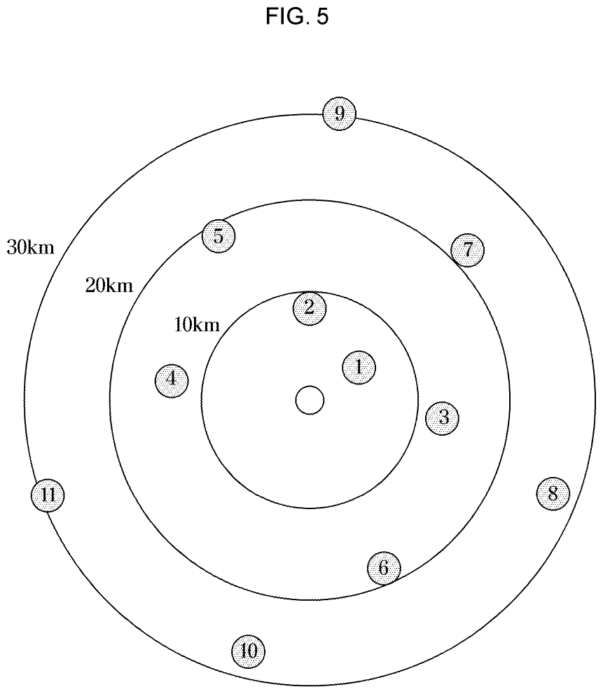

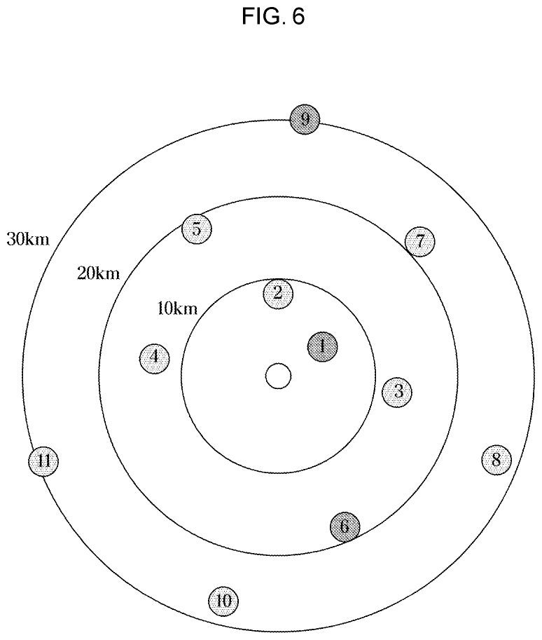

FIG. 4 illustrates a method, performed by a vehicle, of preventing deep discharging of a battery, according to an exemplary embodiment of the present disclosure. FIG. 5 and FIG. 6 illustrate an example of identifying a location of a charging station as shown in FIG. 4.

Referring to FIG. 4, the vehicle may operate in the second mode, in operation 1110.

When the user inputs a user input for switching to the second mode, the shift state is the parking state, and the parking brake is engaged, in the first mode, then the vehicle may switch to the second mode.

In the second mode, even when the accelerator pedal is stepped on, the controller 110 may block supply of a high-voltage power to the driving motor and the vehicle may not be driven. Furthermore, the controller 110 may allow the second battery 140 to supply a low-voltage power to the second load 70 and allow the first battery 120 to supply a power to the second battery 140.

In the second mode, the vehicle may identify whether a charging plug is connected, in operation 1120.

The vehicle may identify whether the charging plug for charging the first battery 120 is inserted into the vehicle. The controller 110 of the power source device 100 may obtain information related to whether the charging plug is inserted into the vehicle, through the communication network, and identify whether the charging plug is inserted into the vehicle, based on the obtained information.

When the charging plug is connected (Yes in operation 1120), the vehicle may continue discharging the first battery 120, in operation 1125.

When the charging plug is connected, the first battery 120 may be charged. Thus, the controller 110 may also allow the first battery 120 and the second battery 140 to be discharged without limitation.

When the charging plug is not connected (No in operation 1120), the vehicle may identify whether a first reference time has elapsed since switching to the second mode, in operation 1130.

The controller 110 may include a timer for counting time. The controller 110 may activate the timer upon switching to the second mode and identify a time elapsing from switching to the second mode.

The controller 110 may compare the time counted by the timer with the first reference time and identify whether the time elapsing after the second mode is equal to or greater than the first reference time.

When the first reference time has not elapsed since switching to the second mode (No in operation 1130), the vehicle may continue operating in the second mode.

When the first reference time has elapsed since switching to the second mode (Yes in operation 1130), the vehicle may search for a charging station in a preset distance, in operation 1140.

The controller 110 may request, to the navigation 20, information related to charging stations located within a predetermined set distance.

The navigation 20 may search for charging stations located within a preset distance from the vehicle, in response to a request of the controller 110. For example, as illustrated in FIG. 5, the navigation 20 may search for charging stations located at a radius of 10 km from the vehicle.

The navigation 20 may provide information of the found charging stations, such as identifiers, traveling distances to the charging stations, etc., to the controller 110. For example, as illustrated in FIG. 5, the navigation 20 may provide a traveling distance to a charging station 1 and a traveling distance to a charging station 2 to the controller 110.

The controller 110 may identify the number of charging stations located within a set distance and a traveling distance to each charging station, based on the information obtained from the navigation 20.

The vehicle may identify whether the number of found charging stations is equal to or greater than a reference value, in operation 1150.

The controller 110 may identify the number of charging stations located within a set distance and identify whether the number of charging stations is equal to or greater than the reference value, based on the information obtained from the navigation 20. For example, the controller 110 may identify whether the number of found charging stations is equal to or greater than 11.

When the number of found charging stations is less than the reference value (No in operation 1150), the vehicle may identify whether the set distance is equal to or greater than a reference distance in operation 1160.

The reference distance may be set experimentally or empirically, and may be set to a maximum value of a distance the vehicle generally moves for charging.

The controller 110 may compare the set distance with the reference distance and identify whether the set distance is equal to or greater than the reference distance.

When the preset distance is less than the reference distance (No in operation 1160), then the vehicle may increase the set distance in operation 1170.

When the number of found charging stations within the set distance is less than the reference value and the set distance is less than the reference distance, the controller 110 may increase the set distance to further search for a charging station. For example, as illustrated in FIG. 5, when two charging stations are found within 10 km, the controller 110 may increase the set distance to 20 km.

Accordingly, the controller 110 may search for a charging station within a set distance, and may repeat increasing the set distance when the number of charging stations is less than the reference value.

When the number of charging stations is equal to or greater than the reference value (Yes in operation 1150), the vehicle may identify an actual traveling distance to each charging station in operation 1180.

The controller 110 may identify the actual traveling distance to each charging station located within the set distance, based on the information obtained from the navigation 20.

For example, as illustrated in FIG. 6, 11 charging stations located within a set distance of 30 km may be found, and the controller 110 may identify an actual traveling distance to each of the 11 charging stations.

When the set distance is equal to or greater than the reference value (Yes in operation 1160), the vehicle may identify an actual traveling distance to each charging station in operation 1180.

For example, when the increased set distance is equal to or greater than 100 km, the controller 110 may identify the actual traveling distance to each charging station located within the set distance, based on the information obtained from the navigation 20.

The vehicle may respectively identify a charging station having a maximum actual traveling distance, a charging station having a middle actual traveling distance, and a charging station having a minimum actual traveling distance in operation 1190.

The vehicle may respectively identify a charging station having a maximum actual traveling distance, a charging station having a middle actual traveling distance, and a charging station having a minimum actual traveling distance, based on an actual traveling distance to each of the found charging stations.

For example, as illustrated in FIG. 6, the controller 110 may identify a charging station 9 having a maximum actual traveling distance, a charging station 6 having a middle actual traveling distance, and a charging station 1 having a minimum actual traveling distance, based on distances.

The vehicle may respectively store the charging station having the maximum actual traveling distance, the charging station having the middle actual traveling distance, and the charging station having the minimum actual traveling distance.

As described above, after entering the second mode, the vehicle may search for a charging station for charging the vehicle and respectively store a charging station having a maximum actual traveling distance, a charging station having a middle actual traveling distance, and a charging station having a minimum actual traveling distance.

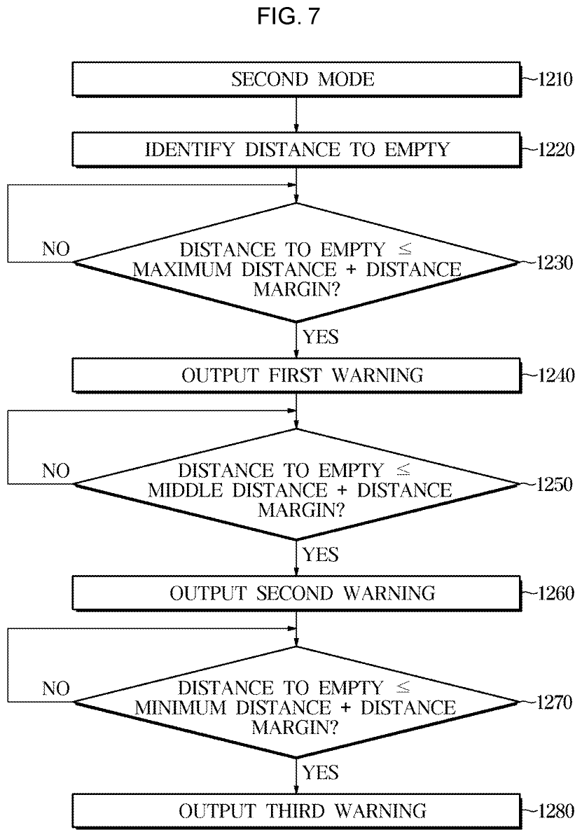

FIG. 7 illustrates a method, performed by a vehicle, of preventing deep discharging of a battery, according to an exemplary embodiment of the present disclosure.

Referring to FIG. 7, the vehicle may operate in the second mode, in operation 1110.

In the second mode, even when the accelerator pedal is stepped on, the controller 110 may block supply of a high-voltage power to the driving motor and the vehicle may not be driven. Furthermore, the controller 110 may allow the second battery 140 to supply a low-voltage power to the second load 70 and allow the first battery 120 to supply a power to the second battery 140.

In the second mode, the vehicle may identify a distance to empty in operation 1220.

The controller 110 may identify the distance to empty, based on an average energy efficiency of the vehicle, an SOC value of the first battery 120, and a capacity of the first battery 120.

The controller 110 may determine an average energy efficiency of the vehicle while driving of the vehicle. The average energy efficiency of the vehicle may indicate a distance the vehicle may move per unit capacity of the first battery 120. The average energy efficiency may largely change according to a season due to heating, cooling, etc. Thus, the average energy efficiency of the vehicle may be an average energy efficiency of, for example, the last week or the last month.

The controller 110 may receive the SOC value of the first battery 120 from the first sensor 130 through the communication network. Furthermore, the controller 110 may store the capacity of the first battery 120 in advance.

The controller 110 may identify the distance to empty, based on a product of the average energy efficiency of the vehicle, the SOC value of the first battery 120, and the capacity of the first battery 120.

The controller 110 may determine the distance to empty of the vehicle every set time based on a time for which the first battery 120 is available (hereinafter, referred to as an ‘available time’ of the first battery 120).

The controller 110 may identify a current power amount of the first battery 120 based on a product of the SOC value of the first battery 120, the capacity of the first battery 120, and an efficiency of the first battery 120.

The controller 110 may identify a power usage amount of the vehicle in the second mode, based on a sum of a power usage amount of the air conditioner, a power usage amount of the second load 70, and a power usage amount for battery management.

The controller 110 may identify the available time of the first battery 120 based on a quotient obtained by dividing the current power amount of the first battery 120 by the power usage amount of the vehicle in the second mode.

When the available time of the first battery 120 exceeds one hour, the controller 110 may re-determine the distance to empty of the vehicle upon elapse of a half of the available time of the first battery 120.

When the available time of the first battery 120 is less than or equal to one hour, the controller 110 may determine the distance to empty of the vehicle every 10 minutes.

When the available time of the first battery 120 is less than or equal to 30 minutes, the controller 110 may determine the distance to empty of the vehicle every 5 minutes.

Thereafter, the vehicle may identify whether the distance to empty of the vehicle is less than or equal to a sum of a maximum distance to a charging station and a distance margin, in operation 1230.

The controller 110 may identify a sum of a traveling distance to a charging station having a maximum actual traveling distance and the distance margin. The distance merging may be set experimentally or empirically, and may be set to, for example, 20 km. For example, the controller 110 may identify a sum of a traveling distance to the charging station 9 and the distance margin.

The controller 110 may compare the distance to empty identified in operation 1220 with the sum of the maximum distance and the distance margin, and identify whether the distance to empty is less than or equal to the sum of the maximum distance and the distance margin.

When the distance to empty exceeds the sum of the maximum distance and the distance margin (No in operation 1230), the vehicle may re-determine the distance to empty after a preset period based on the available time of the first battery 120, and identify whether the distance to empty is less than or equal to the sum of the maximum distance and the distance margin.

When the distance to empty is less than or equal to the sum of the maximum distance and the distance margin (Yes in operation 1230), the vehicle may output a first warning in operation 1240.

The controller 110 may transmit a communication signal to the display 50 to display a message indicating the first warning. The display 50 may output the message indicating the first warning, in response to the communication signal of the controller 110.

Thereafter, the vehicle may identify whether the distance to empty of the vehicle is less than or equal to a sum of a middle distance to the charging station and the distance margin, in operation 1250.

The controller 110 may identify a sum of a traveling distance to a charging station having a middle actual traveling distance and the distance margin. For example, the controller 110 may identify a sum of a traveling distance to the charging station 6 and the distance margin.

The controller 110 may compare the distance to empty identified in operation 1220 with the sum of the middle distance and the distance margin, and identify whether the distance to empty is less than or equal to the sum of the middle distance and the distance margin.

When the distance to empty exceeds the sum of the middle distance and the distance margin (No in operation 1250), the vehicle may re-determine the distance to empty after a preset period based on the available time of the first battery 120, and identify whether the distance to empty is less than or equal to the sum of the middle distance and the distance margin.

When the distance to empty is less than or equal to the sum of the middle distance and the distance margin (Yes in operation 1250), the vehicle may output a second warning in operation 1260.

The controller 110 may transmit a communication signal to the display 50 to display a message indicating the second warning. The display 50 may output the message indicating the second warning, in response to the communication signal of the controller 110.

Thereafter, the vehicle may identify whether the distance to empty of the vehicle is less than or equal to a sum of a minimum distance to the charging station and the distance margin, in operation 1270.

The controller 110 may identify a sum of a traveling distance to a charging station having a minimum actual traveling distance and the distance margin. For example, the controller 110 may identify a sum of a traveling distance to the charging station 1 and the distance margin.

The controller 110 may compare the distance to empty identified in operation 1220 with the sum of the minimum distance and the distance margin, and identify whether the distance to empty is less than or equal to the sum of the minimum distance and the distance margin.

When the distance to empty exceeds the sum of the minimum distance and the distance margin (No in operation 1270), the vehicle may re-determine the distance to empty after a preset period based on the available time of the first battery 120, and identify whether the distance to empty is less than or equal to the sum of the minimum distance and the distance margin.

When the distance to empty is less than or equal to the sum of the minimum distance and the distance margin (Yes in operation 1270), the vehicle may output a third warning in operation 1280.

The controller 110 may transmit a communication signal to the display 50 to display a message indicating the third warning. The display 50 may output the message indicating the third warning, in response to the communication signal of the controller 110.

As described above, the vehicle may compare a distance to empty based on the remaining capacity of a battery with a traveling distance to a charging station, and step wisely warn a user for shortage of the remaining capacity of the battery based on a comparison result. Hence, it is possible to restrain or prevent the vehicle from being unable to be driven due to deep discharging of the battery in the second mode.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle comprising:
a driving motor;
an electric load;
a first battery electrically connected to the driving motor and configured to supply a power of a first voltage to the driving motor;
a second battery electrically connected to the electric load and configured to supply a power of a second voltage to the electric load;
a direct-current converter electrically connected to the first battery and the second battery between the first battery and the second battery; and
a controller operatively connected to the direct-current converter and configured to control the direct-current converter to supply the power of the first battery to the second battery and to warn a low state of charge (SOC) value of the first battery based on an SOC value of the first battery and a distance of the vehicle to a charging station for charging the first battery during supply of the power of the first battery to the second battery.

2. The vehicle of claim 1, wherein the controller is further configured to receive, from a navigation of the vehicle, information related to a plurality of charging stations located within a predetermined distance from the vehicle during the supply of the power of the first battery to the second battery.

3. The vehicle of claim 2, wherein the controller is further configured to increase the predetermined distance and receive information related to a plurality of charging stations located within the increased predetermined distance from the navigation, when a number of the plurality of charging stations located within the predetermined distance is less than a reference value and the predetermined distance is less than a reference distance.

4. The vehicle of claim 2, wherein the controller is further configured to identify a maximum value, a minimum value, and a middle value of an actual traveling distance in the vehicle to each of the charging stations.

5. The vehicle of claim 4, wherein the controller is further configured to:
identify a distance to empty of the vehicle based on the SOC value of the first battery and an average energy efficiency of the vehicle; and
warn the low SOC value of the first battery based on a result of comparing each of the maximum value, the minimum value, and the middle value of the actual traveling distance with the distance to empty.

6. The vehicle of claim 5,
wherein the warning includes a first warning, a second warning and a third warning, and
wherein the controller is further configured to:
output the first warning when the distance to empty of the vehicle is less than the maximum value of the actual traveling distance;
output the second warning when the distance to empty of the vehicle is less than the middle value of the actual traveling distance; and
output the third warning when the distance to empty of the vehicle is less than the minimum value of the actual traveling distance.

7. The vehicle of claim 5, wherein the controller is further configured to:
identify an available time of the first battery based on the SOC value of the first battery and a power consumption per unit time of the electric load; and
identify the distance to empty in each period based on the available time.

8. The vehicle of claim 5, wherein the controller is further configured to identify the average energy efficiency of the vehicle during a predetermined time period.

9. The vehicle of claim 1, wherein the controller is further configured to:
allow the first battery to supply the power of the first voltage to the driving motor and the second battery to supply the power of the second voltage to the electric load, in a first mode; and
block supply of the power of the first voltage to the driving motor from the first battery and allow the second battery to supply the power of the second voltage to the electric load, in a second mode.

10. The vehicle of claim 9, wherein the controller is further configured to switch to the second mode when a shift state of the vehicle is a parking state, a parking brake of the vehicle is engaged, and a user input for switching to the second mode is obtained, in the first mode.

11. A method of controlling a vehicle, the method comprising:
supplying, by a first battery of the vehicle, a power of a first voltage to a driving motor electrically connected to the first battery;
supplying, by a second battery of the vehicle, a power of a second voltage to an electric load electrically connected to the second battery;
supplying the power of the first battery to the second battery;
warning, by a controller, a low state of charge (SOC) value of the first battery based on an SOC value of the first battery and a distance of the vehicle to a charging station for charging the first battery during supply of the power of the first battery to the second battery.

12. The method of claim 11, further including:
receiving, by the controller, information related to a plurality of charging stations located within a predetermined distance from the vehicle, from a navigation of the vehicle, during the supply of the power of the first battery to the second battery.

13. The method of claim 12, wherein the receiving of the information related to the plurality of charging stations includes:
increasing the predetermined distance and receiving information related to a plurality of charging stations located within the increased predetermined distance from the navigation, when a number of the plurality of charging stations located within the predetermined distance is less than a reference value and the predetermined distance is less than a reference distance.

14. The method of claim 12, further including:
identifying, by the controller, a maximum value, a minimum value, and a middle value of an actual traveling distance in the vehicle to each of the charging stations.

15. The method of claim 14, further including:
identifying, by the controller, a distance to empty of the vehicle based on the SOC value of the first battery and an average energy efficiency of the vehicle; and
warning, by the controller, the low SOC value of the first battery based on a result of comparing each of the maximum value, the minimum value, and the middle value of the actual traveling distance with the distance to empty.

16. The method of claim 15,
wherein the warning includes a first warning, a second warning and a third warning, and
wherein the method further includes:
outputting, by the controller, the first warning when the distance to empty of the vehicle is less than the maximum value of the actual traveling distance;
outputting, by the controller, the second warning when the distance to empty of the vehicle is less than the middle value of the actual traveling distance; and
outputting, by the controller, the third warning when the distance to empty of the vehicle is less than the minimum value of the actual traveling distance.

17. The method of claim 15, further including:
identifying, by the controller, an available time of the first battery based on the SOC value of the first battery and a power consumption per unit time of the electric load; and
identifying, by the controller, the distance to empty in each period based on the available time.

18. The method of claim 15, further including identifying, by the controller, the average energy efficiency of the vehicle during a predetermined time period.

19. The method of claim 11, further including:
allowing, by the controller, the first battery to supply the power of the first voltage to the driving motor and the second battery to supply the power of the second voltage to the electric load, in a first mode; and
blocking, by the controller, supply of the power of the first voltage to the driving motor from the first battery and allowing the second battery to supply the power of the second voltage to the electric load, in a second mode.

20. The method of claim 19, further including switching, by the controller, to the second mode when a shift state of the vehicle is a parking state, a parking brake of the vehicle is engaged, and a user input for switching to the second mode is obtained, in the first mode.
